(19) United States
(12) Patent Application Publication
(10) Pub. No.: US 2005/0280979 A1
(43) Pub. Date: Dec. 22, 2005

(54) Power source cabinet

(76) Inventor: Qin Yue Wu, Shenzhen City (CN)

Correspondence Address: Raymond Y. Chan, 108 N. Ynez Ave., #128, Monterey Park, CA, 91754, US

(21) Appl. No.: 11/148,767

(22) Filed: Jun. 8, 2005

(30) Foreign Application Priority Data
Jun. 8, 2004 (CN) 200420046918. 1

(51) Int. Cl. H01K 1/62

(52) U.S. Cl. 361/625

(57) ABSTRACT

The utility model discloses a power source cabinet comprising a power source disposed within the cabinet body, an inverter portion connected to the power source, an air pump portion powered by the output power source of the inverter, positive and negative electrical clips connected to the power source, placed within the electrical clip box on both sides of the cabinet body, and respectively connected to the positive and negative of the power source, and a function panel disposed on the cabinet body. Thereby the battery will be protected from being easily damaged, have a prolonged lifespan, be convenient to use, be safe and reliable while charging, and motor vehicles will be started easily.

### BACKGROUND OF THE INVENTION

1. Field of Invention

The utility model relates to a power source cabinet, and particularly to an onboard power source cabinet capable of supplying power to various instruments.

2. Related Art

In general, an onboard power source comprises an inverter power source and a DC power source. The DC power source is usually used to start the vehicle and to power the air pump, while the inverter power source is generally used to supply proper voltages to some power-consuming equipments, such as a computer, a television, electric tools, and a mobile phone charger. The ordinary DC power source is chargeable and dischargeable battery. Since the power sources are in a separated form, they are selected to be moved or connected as desired when being disposed and used. Thus, it is easy for the batteries to be damaged and inconvenient for using. And meanwhile, the batteries do not have any indication when being charged, and the positive and the negative of the batteries may be misconnected when used for starting vehicles, which will cause the potential risks.

### SUMMARY OF THE INVENTION

The object of the present invention is to provide a power supply cabinet to overcome the disadvantages of the technique described above; wherein said power supply cabinet can prevent batteries from being easily damaged and provide them with a prolonged lifespan and a convenient operation, and meanwhile the vehicles are readily started, and it is safe and reliable for charging the batteries. In addition, the low-voltage currents, after being inverted through such power supply cabinet, may be used for a computer, a television, electric tools, a mobile phone charger, and the like. Such power supply cabinet is also equipped with a light for illumination.

Technical Solution

The utility model is accomplished through the following technical solutions:

The power supply cabinet comprises a power source disposed within the cabinet body, positive and negative electrical clips connected to the power source, placed within the electrical clip box on both sides of the cabinet body, and respectively connected to the positive and negative of the battery; and a function panel disposed on the cabinet body.

The power supply cabinet further comprises an inverter portion connected to the power source, and an air pump portion powered by the output power source of the inverter.

Wherein the inverter portion comprises an inverter mounted within the cabinet, a test button, a LED display screen, and an inverter switch disposed on the function panel. And the switch is provided with sockets on both sides. The inverter is located in the middle part of the cabinet body, while the corresponding inverter switch is disposed on the middle part of the function panel. The sockets are disposed on both sides of the switch, and the LED display screen, that is a three digit LED digital display, is disposed below the switch.

Wherein the air pump portion comprises a pump body mounted within the cabinet body, and a gas meter, a fuse box and an air pump switch disposed on the function panel. The air pump is disposed at the most front end of the cabinet body, while the corresponding gas meter is disposed at the front end of the function panel. The fuse box and the air pump switch are disposed on both sides of the gas meter, and a fuse is disposed within the fuse box.

An electrical clip switch is disposed on one end of the function panel, and one side of the electrical clip switch is provided with a charge jack and the LED display color light. And the color light is partially connected to the charging circuit, which is disposed within the cabinet body and connected to the power supply.

A movable front door is disposed on the end face vertical to the function panel. The lower end of the movable front door is connected to the cabinet body by a hinge, and a snap fastener is disposed in the middle part of the upper end. The air pump is disposed within the cabinet body behind the movable front door.

Wherein the charging circuit portion comprises a charging circuit and an electric quantity detecting circuit, and the charging circuit includes a charging limited current circuit, an overcharge protection and display circuit,
wherein the charging and limited current circuit is composed of J1, D5, K1, and R14, connected in series;
the overcharge protection and display circuit is consisted of D8, D6, ZD1, R12, Q2, R11, LED D1, R13, Q1, and R8. Specifically, D8 is connected with K1 in parallel. D6, ZD1, and R12 are connected in series and then with K1 in parallel. The base of Q2 is connected to R12; the emitter of Q2 is connected to ground; and the collector of Q2 is connected to D8. One end of R11 and one end of R13 are connected to K1. LED D1 is connected with R11 in series and with R13 in parallel. The base of Q1 is connected to one end of R13; the emitter of Q1 is connected to ground; and the collector of Q1 is connected between R8 and D1.
the electric quantity detecting circuit is consisted of U1A, U1B, U1C, R1, R2, R3, R4, R8, R9, R10, D1, D2, D3, D7, C1, C2, SW1, BT1, R5, R6, R7, and U2. Specifically, U1A, U1B, and U1C are connected in parallel. The first pin of U1A is connected to D7, while the other end of D7 is connected to R8. The second pin of U1A is connected to the ninth pin of U1C. The third and fourth pins of U1A are respectively connected to two ends of R1. The fifth pin of U1B is connected to ground via C1; the sixth pin of U1B is connected to one end of R2, and the seventh pin of U 1B is connected to one end of R9, while the other end of R9 is connected to D2, and the other end of D2 is connected to ground. The eighth pin of U1C is connected to one end of R10, while R10 is connected with D3 in series and then connected to ground. The ninth pin of U1C is also connected to the third pin of U2 and R7, while R7 is connected with R6 in series and then to ground. And the first pin of U2 is connected between R6 and R7, while the second pin of U2 is connected to ground. The tenth pin of U1C is connected with R4 and R5, and the other end of R5 is connected to ground. Furthermore, SW1 is connected to the positive of BT1 and R14; the negative of BT1 is connected to ground; and C2 is connected between the other end of SW1 and the ground.

The inverter in the inverter portion is located in the middle part of the cabinet body; while the corresponding inverter switch is disposed on the middle part of the function panel. The sockets are disposed on both sides of the switch, and the LED display screen, that is a three digit LED digital display, is disposed below the switch.

The electrical clip switch is a knob with on/off shift, and a reset switch F1 is disposed between the positive electrical clip and the battery.

The function panel, where the electrical clip switch is located, is inclined at an angle of less than 90°.

The left and right handles are disposed on both sides of the power supply cabinet body for moving and handholding. And the handles are covered with handle covers, protruding from the surface of the cabinet body and forming a space with the cabinet body for fingers to insert.

A pair of cigarette lighter charge jacks is disposed above the charge jack on the function panel, above which a cover board hinged with the function panel are placed.

The cover board is located on the function panel, where the electrical clips are placed.

The cover board may also be movably connected to the function panel by a hinge.

An upper cover, movably connected to the cabinet body at the joint between the slope and plane of the function panel by the hinge, is disposed on the panel portion of the function panel, and a light connected to the power source is disposed at the bottom of the upper cover.

Beneficial Effects

The beneficial effects of the utility model are as follows:
1. The cabinet body supports the battery to protect the battery from being damaged, thus prolonging lifespan of the battery;
2. Charge indicator are disposed and the power is digitally displayed, such that the electric quantity may be controlled at any moment; precautionary measures may be well taken; thus ensuring the battery is fully charged.
3. The electrical clips are clamped to the positive and negative of the battery within the vehicles, such that the vehicles are rapidly started.
4. The output of the electrical clips is provided with an overload protection switch, thus ensuring the vehicles to be started safely.
5. A high-pressure air pump is disposed in combination, which can be used to pump the tires of the car conveniently.

### BRIEF DESCRIPTION OF THE DRAWINGS

FIG. 1 is a three dimensional view of a power supply cabinet (when the electrical clip is charged) of the utility model;

FIG. 2 is a top view of the power supply cabinet of FIG. 1;

FIG. 3 is a front view of the power supply cabinet of FIG. 1 (with the movable front door 17 opened);

FIG. 4 is a cutaway view of the power supply cabinet of FIG. 1 along line A-A;

FIG. 5 is a charging circuit diagram of the power source.

### DETAILED DESCRIPTION OF THE INVENTION

The utility model will be further illustrated in conjunction with the accompanying figures below.

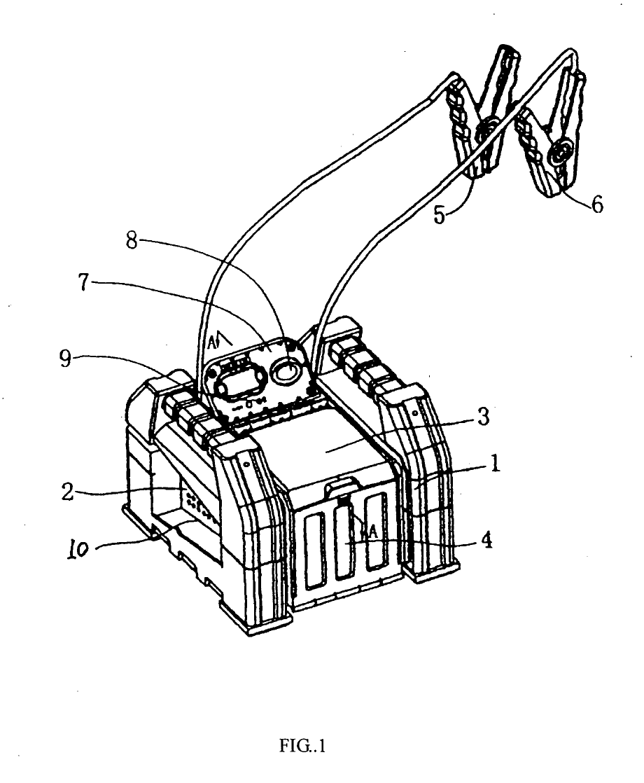

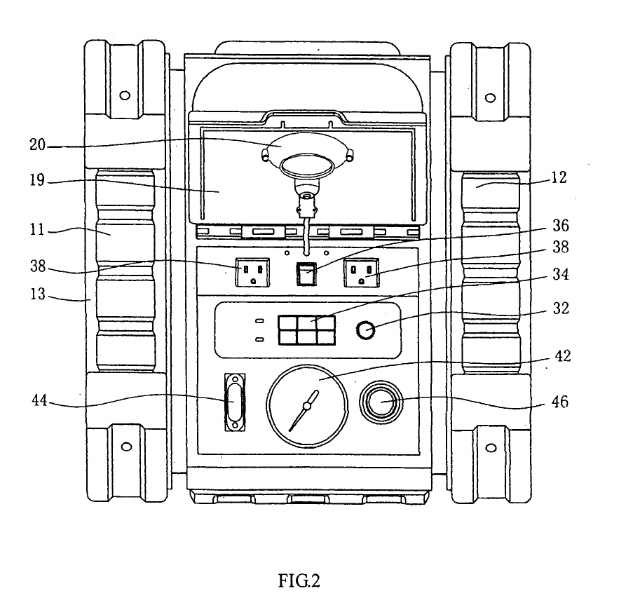

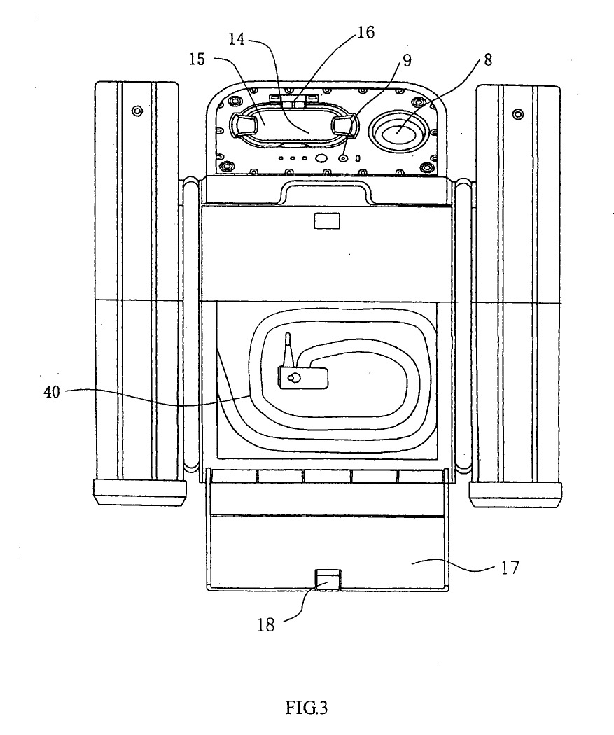

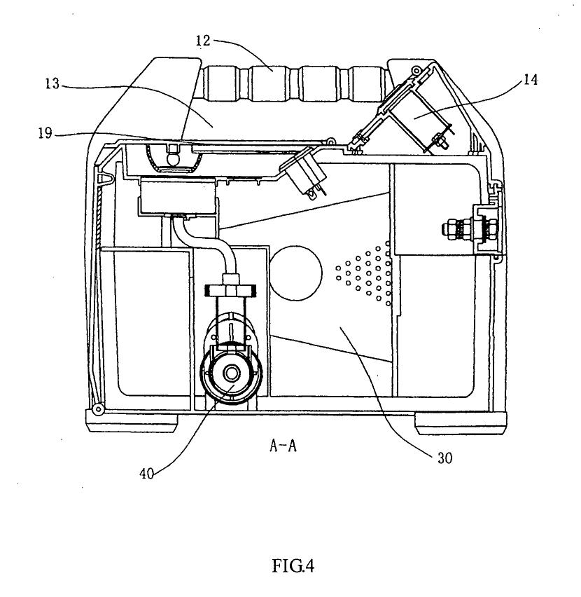

As shown in FIG. 1 to FIG. 4, the power supply cabinet of the utility model comprises a power source 2 disposed within the cabinet body 1, an inverter portion 3 connected to the power source 2, an air pump portion 4 powered by the output power source of the inverter, positive and negative electrical clips 5, 6 connected to the power source 2, placed within the electrical clip box 10 on both sides of the cabinet body and respectively connected to the positive and negative of the power source, and a function panel 7 placed on the cabinet body 1; wherein, the inverter portion 3 includes an inverter 30 mounted within the cabinet, and a test button 32, a LED display screen 34 and an inverter switch 36 with sockets 38 on both sides disposed on the function panel 7. The inverter 30 is located in the middle part of the cabinet body. The corresponding inverter switch 36 is disposed on the middle part of the function panel. Sockets 38 are disposed on both sides of the switch 36, and the LED display screen 34 that is a three digit LED digital display is disposed below the switch 36. Pressed down the test button 32 before the inverter is powered, and the LED display screen 34 will show the voltage output by the battery; while such display screen shows the output power when the inverter is on. The air pump portion 4 includes a pump body 40 mounted within the cabinet, and a gas meter 42, a fuse box 44 and an air pump switch 46 disposed on the function panel 7. The air pump 40 of the air pump portion is disposed at the most front end of the cabinet body 1. The corresponding gas meter 42 is disposed at the front end of the function panel 7. The fuse box 44 and the air pump switch 46 are disposed on both sides of the gas meter 42. A fuse is disposed within the fuse box for protecting overload. Furthermore, One end of the function panel 7 is inclined at an angle of less than 90° extending upward, on which an electrical clip switch 8 is disposed. The clip switch 8 is a knob having on/off shift. A reset switch F1 is disposed between the positive electrical clip and the battery. A charge jack 9 used as an interface for charging and three LED display color lights D1, D2 and D3 are disposed on one side of the electrical clip switch 8, in which the color lights are partially connected to the charging circuit 92 which is disposed within the cabinet body 1 and connected to the power supply 2. Additionally, left and right handles 11,12 are disposed on both sides of the power supply cabinet body 1, which are covered with handle covers, protruding from the surface of the cabinet body and forming a space 13 for fingers to insert. A pair of cigarette lighter charge jacks 14 is disposed above the charge jack on the inclined function panel, with a cover board 15 hinged with the function panel placed upon. The cover board 15 is movably connected to the function panel by a hinge 16. A movable front door 17 is disposed on the end face vertical to the function panel, with its lower end connected to the cabinet body 1 by a hinge, and a snap fastener 18 disposed in the middle part of its upper end. An air pump 40 is disposed within the cabinet body behind the movable front door 17. The movable front door 17 can be open while using so as to draw out gas nozzle of the air pump from the door. An upper cover 19, which is movably connected to the cabinet body at the joint between the slope and plane of the function panel by a hinge, is disposed on the plane portion of the function panel. A light 20 connected to the power source is disposed at the bottom of the upper cover 19.

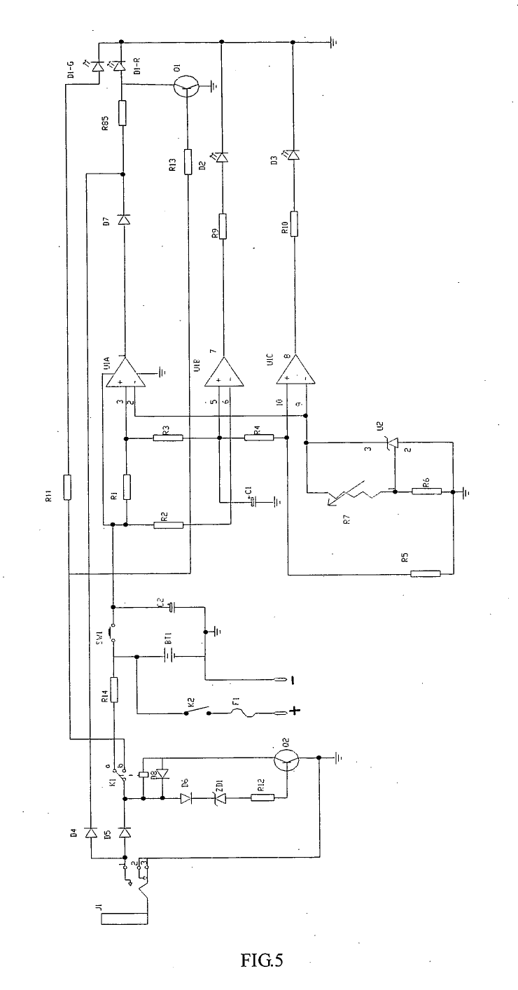

As shown in FIG. 5, the positive of the power source BT1 is connected to the positive electrical clip, and the negative of the power source BT1 is connected to the negative electrical clip. The switch K2 and the reset switch F1 are connected between the positive of the power source BT1 and the positive electrical clip. If load short-circuit or overload occurs or the electrical clips are connected to improper positive and negative when the electrical clip outputs, the reset switch F1 will jump rapidly, the red light lights up, and such switch can be reset by the operators after 5-8 seconds. The charging circuit portion includes a charging circuit and an electric quantity detecting circuit, wherein the charging circuit of the power source includes a charging limited current circuit, an overcharge protection and display circuit, wherein, the charging and limited current circuit is consisted of J1, D5, K1 and R14, which are connected in series; the overcharge protection and display circuit is consisted of D8, D6, ZD1, R12, Q2, R11, LED D1, R13, Q1 and R8. Specifically, D8 is connected with K1 in parallel. D6, ZD1 and R12 are connected in series and then with K1 in parallel. The base of Q2 is connected to R12, the emitter of Q2 is connected to ground, and the collector of Q2 is connected to D8. One end of R11 and one end of R13 are connected to K1. LED D1 is connected with R11 in series and with R13 in parallel. The base of Q1 is connected to one end of R13, the emitter of Q1 is connected to ground, and the collector of Q1 is connected between R8 and D1. The electric quantity detecting circuit is consisted of U1A, U1B, U1C, R1, R2, R3, R4, R8, R9, R10, D1, D2, D3, D7, C1, C2, SW1, BT1, R5, R6, R7 and U2. Specifically, U1A, U1B and U1C are connected in parallel. The first pin of U1A is connected to D7 and the other end of D7 is connected to R8. The second pin of U1A is connected to the ninth pin of U1C. The third and fourth pins of U1A are respectively connected to two ends of R1. The fifth pin of U1B is connected to ground via C1. The sixth pin of U1B is connected to one end of R2. The seventh pin of U1B is connected to one end of R9. The other end of R9 is connected to D2, and the other end of D2 is connected to ground. The eighth pin of U1C is connected to one end of R10 which is connected with D3 in series and then to ground. The ninth pin of U1C is also connected to the third pin of U2 and R7 that is connected with R6 in series and then to ground. The first pin of U2 is connected between R6 and R7, and the second pin of U2 is connected to ground. The tenth pin of U1C is connected to R4 and R5, and the other end of R5 is connected to ground. Furthermore, SW1 is connected to the positive of BT1 and R14. The negative of BT1 is connected to ground. C2 is connected between the other end of SW1 and the ground. When charging, after the power source passes through the charge socket J1, its positive is output to a diode D5 through pin 1 of J1, and then via normally closed contacts K1˜a connected to the positive of the battery BT1 after being current-limited by the resistor R14, and its negative is connected to the negative of BT1 via pins 2 and 3 of J1, thus forming a charge loop. Meanwhile, pin 1 of the charge socket is connected to the negative of the power source via diode D4, resistor R8, two-color LED and D1-R to allow D1-R light up to indicate that charging is in process. When the battery is charged to a predetermined voltage, ZD1 voltage-stabilizing diode breaks down, and triode Q2 is conducted. When the relay K1 picks up, K1˜a drops out, and K1-b picks up, the battery disconnects from the charge loop, and charge is completed. D1-G lights up after being powered, and triode Q1 is conducted after being powered via the resistor R13. The potential of the first pin of D1-G is drawn down to have D1-R turned off to indicate that charging is completed. For the electric quantity detecting circuit: press down SW1, and the current is input to pin 4 of U1A after being filtered by C2, and then via R2 reach the second pin of U1A, pin 6 of U1B and pin 9 of U1C (inverting input terminal), and at the same time the current flows to pin 3 of U1A, pin 5 of U1B, pin 10 of U1C (inphase input terminal) and pin 2 of U2 via a voltage divider consisted of R1, R3, R4 and R5; R2, R7, R6 and U2 form a regular power source so as to provide a reference voltage for pin 2 of U1A, pin 6 of U1B, pin 9 of U1C (inverting input terminal). If the voltage of the third pin is higher than that of the second pin, the first pin outputs high potential to the negative of the battery via D7, D8 and D1-R, so that D1-R lights up. If the voltage of the fifth pin is higher than that of the sixth pin, the seventh pin outputs high potential to the negative of the battery via R9 and D2, so that D2 lights up. If the voltage of the tenth pin is higher than that of the ninth pin, the eighth pin outputs high potential to the negative of the battery via R10 and D2, so that D3 lights up. Here, press down SW1, if D1, D2 and D3 light up simultaneously, indicating that the battery is full and can be normally used. If D1 and D2 light up simultaneously, indicating that the voltage of battery is lower than normal, and needs charging. If D1-R lights up individually, indicating that the battery cannot be used normally, and needs charging immediately.

In view of the above, the power source cabinet of the utility model supports the battery by the cabinet body to protect the battery from being damaged, thus prolonging lifespan of the battery, and is provided with a charge indicator and digital power display for showing the electric quantity so as to allow people prepare measures, thus ensuring the battery is fully charged. The electrical clips can be connected to the negative and positive of the battery of the automobile to let the vehicles start rapidly. The output of the electrical clips is provided with an overload protection switch, thus ensuring that the motor vehicles can be safely started. Using together with a high pressure air pump, the present power source cabinet can provide convenience for users to pump a small vehicle.

1. A power source cabinet, comprising a power source disposed within the cabinet body; positive and negative electrical clips connected to the power source and placed within the electrical clip box on both sides of the cabinet body, which can be respectively connected to the positive and negative of the battery; and a function panel disposed on the cabinet body.

2. The power source cabinet according to claim 1, further comprising an inverter portion connected to the power source and an air pump portion powered by the output power source of the inverter.

3. The power source cabinet according to claim 2, wherein the inverter portion comprises an inverter mounted within the cabinet, and a test button, a LED display screen and an inverter switch disposed on the function panel; the switch provided with sockets on both sides, the inverter located in the middle part of the cabinet body, the corresponding inverter switch disposed on the middle part of the function panel, the sockets disposed on both sides of the switch, and the LED display screen that is a three digit LED digital display disposed below the switch.

4. The the power source cabinet according to claim 2, wherein the air pump portion comprises a pump body mounted within the cabinet body, and a gas meter, a fuse box and an air pump switch disposed on the function panel; the air pump disposed at the most front end of the cabinet body, the corresponding gas meter disposed at the front end of the function panel, and the fuse box and the air pump switch disposed on both sides of the gas meter, a fuse being disposed within the fuse box.

5. The power source cabinet according to claim 2, wherein a movable front door is disposed on the end face vertical to the function panel, the lower end of the movable front door connected to the cabinet body by a hinge, a snap fastener disposed in the middle part of the upper end, and the air pump disposed within the cabinet body behind the movable front door.

6. The power source cabinet according to claim 1, wherein one end of the function panel is disposed with an electrical clip switch, a charge jack and a LED display color light placed on one side of the electrical clip switch, the color light partially connected to the charging circuit disposed within the cabinet body and connected to the power supply.

7. The power source cabinet according to claim 5, wherein the charging circuit portion comprises a charging circuit and an electric quantity detecting circuit, the charging circuit including a charging limited current circuit and an overcharge protection and display circuit,
wherein, the charge and limited current circuit is composed of J1, D5, K1 and R14 connected in series;
the overcharge protection and display circuit is consisted of D8, D6, ZD1, R12, Q2, R11, LED D1, R13, Q1 and R8, in which D8 is connected with K1 in parallel; D6, ZD1 and R12 are connected in series and then with K1 in parallel; the base of Q2 is connected to R12, the emitter of Q2 is connected to ground, and the collector of Q2 is connected to D8; one end of R11 and one end of R13 are connected to K1; LED D1 is connected with R11 in series and with R13 in parallel; the base of Q1 is connected to one end of R13, the emitter of Q1 is connected to ground, and the collector of Q1 is connected between R8 and D1;
the electric quantity detecting circuit is consisted of U1A, U1B, U1C, R1, R2, R3, R4, R8, R9, R10, D1, D2, D3, D7, C1, C2, SW1, BT1, R5, R6, R7 and U2, in which U1A, U1B and U1C are connected in parallel; the first pin of U1A is connected to D7, the other end of D7 is connected to R8, the second pin of U1A is connected to the ninth pin of U1C, the third and fourth pins of U1A are respectively connected to two ends of R1; the fifth pin of U1B is connected to ground via C1, the sixth pin of U1B is connected to one end of R2, the seventh pin is connected to one end of R9, the other end of R9 is connected to D2, and the other end of D2 is connected to ground; the eighth pin of U1C is connected to one end of R10, R10 is connected with D3 in series and then connected to ground, the ninth pin of U1C is also connected to the third pin of U2 and R7, R7 is connected with R6 in series and then to ground, and the first pin of U2 is connected between R6 and R7, the second pin of U2 connected to ground, the tenth pin of U1C is connected with R4 and R5, and the other end of R5 is connected to ground; furthermore, SW1 is connected to the positive of BT1 and R14, the negative of BT1 is connected to ground, C2 is connected between the other end of SW1 and the ground; the positive of the power source is connected to the positive electrical clip, and the negative of the power source is connected to the negative electrical clip, K2 and the reset switch F1 are connected between the positive of the power source and the positive electrical clip.

8. The power source cabinet according to claim 1, wherein the electrical clip switch is a knob K2 having on/off shift, with a reset switch F1 disposed between the positive electrical clip and K2.

9. The power source cabinet according to claim 7, wherein the function panel, where the electrical clip switch located, is inclined at an angle of less than 90°.

10. The power source cabinet according to claim 1, wherein left and right handles are disposed on both sides of the power supply cabinet body for moving and handholding, the handles covered with handle covers, protruding from the surface of the cabinet body and forming a space for fingers to insert.

11. The power source cabinet according to claim 1, wherein a pair of cigarette lighter charge jacks is disposed above the charge jack on the function panel, above which a cover board hinged with the function panel are placed.

12. The power source cabinet according to claim 10, wherein the cover board is located on the function panel, where the electrical clips are placed.

13. The power source cabinet according to claim 10, wherein the cover board is movably connected to the function panel by a hinge.

14. The power source cabinet according to claim 1, wherein a movable front door is disposed on the end face vertical to the function panel, the lower end of the movable front door connected to the cabinet body by a hinge, and a snap fastener disposed in the middle of the upper end.

15. The power source cabinet according to claim 1, wherein an upper cover, movably connected to the cabinet body at the joint between the slope and plane of the function panel by the hinge, is disposed on the plane portion of the function panel, and a light connected to the power source is disposed at the bottom of the upper cover.
